(19) United States
(12) Patent Application Publication
(10) Pub. No.: US 2025/0034375 A1
(43) Pub. Date: Jan. 30, 2025

(54) NOVEL RECYCLING PROCESS OF POLYETHYLENE

(71) Applicant: Nexam Chemical AB, Lomma (SE)

(72) Inventors: Francesco PISCIOTTI, Veberöd (SE); Hugo SELLING, Malmö (SE); Amin KEIVANSHOKOUH, Lund (SE); Carlos SOLANO ARRIBAS, Lund (SE)

(73) Assignee: Nexam Chemical AB, Lomma (SE)

(21) Appl. No.: 18/713,697

(22) PCT Filed: Dec. 6, 2022
(86) PCT No.: PCT/EP2022/084649

§ 371 Date: May 27, 2024

(30) Foreign Application Priority Data
Dec. 8, 2021 (EP) 21213147.8

(51) Int. Cl. C08L 23/06; C08J 5/18

(52) U.S. Cl. CPC C08L 23/06; C08J 5/18; C08J 2323/06; C08J 2423/26; C08J 2433/02; C08L 2203/16; C08L 2205/025; C08L 2207/062; C08L 2207/066; C08L 2207/20

(57) ABSTRACT

Recycling of waste products has become increasingly common practice in the last decades. The recycling of plastic materials is important and widely carried out by many industries and households around the world. A multitude of everyday consumer items are made from plastic materials, such as bottles, bags, products, and especially liquid food board-based packaging. It is important to recycle and reuse the polymers.

### TECHNICAL FIELD

The present invention relates to a process for recycling post-consumer and/or post-industrial polyethylene composition. Further, the present invention relates to a re-cycled post-consumer and/or post-industrial polyethylene composition having improved melt flow rate.

### BACKGROUND OF THE INVENTION

Recycling of waste products has become increasingly common practice in the last decades. The recycling of plastic materials is important and widely carried out by many industries and households around the world. A multitude of everyday consumer items is made from plastic materials, such as bottles, bags, products, and especially liquid food board-based packaging. It is important to recycle and reuse the polymers.

However, it is necessary to monitor and ensure the quality of the recycled plastics. An object of particular importance in recycling polyethylene is to meet processability requirements. Polyethylene is recycled from various processes. Recycled polyethylene has at least been used once. The reclaimed polyethylene originates from post-consumer and/or post-industrial uses. Most recycled plastics are mixed into a single stream, which is collected and processed by a material recovery facility. At the material recovery facility, materials are sorted, washed, granulated, and packaged for resale. Plastics can be sorted into individual materials, such as high-density polyethylene (HDPE) or poly (ethylene terephthalate) (PET), or mixed streams of other common plastics, such as polypropylene (PP), low-density polyethylene (LDPE), poly (vinyl chloride) (PVC), polystyrene (PS), polycarbonate (PC), and polyamides (PA). The single or mixed streams can then be further sorted, washed, and reprocessed into a pellet that is suitable for selected purposes. Though recycled plastics are sorted into predominately uniform streams and are washed with aqueous and/or caustic solutions, the final reprocessed streams remain contaminated with other plastic and the properties of the stream vary. For example, there will nearly always be small amount of polypropylene in the recycled polyethylene stream.

One particular stream from post-consumer recycling is liquid food board-packages comprising liquid packaging board. This stream comprises liquid packaging board with and without aluminium layers or other oxygen barrier layers. These packages have an inner layer of plastic. The purpose of this layer is to preserve the liquid food, which can be milk, juice or any other liquid or semi-liquid food and to seal the package. This layer has food approval, typically an LDPE. Next to this layer there can be barrier layers that prevent oxygen diffusion, adhesion layers to either paper board or aluminium or other oxygen barrier layers. The aluminium layer is used as an oxygen barrier. The paper board layer is typically outside the optional aluminium layer. Commonly there is an outer layer made of polyethylene, with an optional adhesion layer to the board. The liquid packaging board in liquid food board-packages are complex, and each layer has different purposes. Most layers/construction comprise polyethylene. Most of the polyethylene is LDPE, but also linear low-density polyethylene (LLDPE) is used. In addition, adhesion layers can be made of ethylene methacrylic acid copolymer (EMAA), ethylene acrylic acid copolymer (EAA) or maleic anhydride grafted polyolefins (MAH). The adhesion layers typically comprise polar polymers. The adhesion layers can be treated by ozone treatment to increase polarity and thus increase adhesion to aluminium layer. The stream further comprises HDPE that originates from caps, commonly grinded.

Delamination of liquid packaging board in the liquid food board-packages is commonly made in a paper mill and the paper fibres are removed with water and recycled.

In the case of a liquid packaging board without aluminium layer the remaining mixture comprises a mixture of laminated polyethylene films and hard plastic components, used for caps and closures, which typically comprise mainly HDPE. The recycled polyethylene stream is in the form of flakes.

In the other case in which the liquid packaging board with an aluminium layer the remaining mixture comprises a mixture of strongly laminated foil of polyethylene and aluminium. It further comprises hard plastic components used for caps and closures, which typically comprise mainly HDPE.

The foil can be separated by several methods such as the one disclosed in U.S. Pat. No. 5,421,525. An improved variant thereof is disclosed in CN101891903B, which describes an acid-based delamination process. The delamination is done in an organic acid solution at elevated temperatures. Examples of organic acids are acetic or formic acids. The aluminium and polyethylene layers are separated. The recycled polyethylene stream is free from aluminium residues and is in the form of flakes.

Other processes for delamination are described in US20,210,86406A1, which comprise a mixture of water, carboxylic acid, carboxylate salt and passivation agent. EP3554834B1 describes a mixture of water carboxylic acid, phosphoric acid and alkali metal. Further methods are described in US10,682,788B2, which comprise water, a swelling agent, an anionic surfactant, a carboxylic acid, and at least one of a co-surfactant or a hydrotrope.

The properties of recycled streams vary. Thus, usefulness of the recycled polyethylene will vary. One solution to this is to test the properties of every lot. This would however be difficult, costly, and impractical. To ensure stable properties of the recycled polyethylene stream resilient solutions must be found that ensure the recycled polyethylene meets the specification for the application.

WO2002088239A1 and US20,050,049335A1 disclose compositions with different types of polyethylene and polyethylene with silane groups. They both require virgin polymers.

Thus, there is a need for a process for up-cycling of post-consumer and post-industrial polyethylene.

As used herein, the term “recycled polymer” refers to a polymer used for a previous purpose and then recovered for further processing.

As used herein, the term “post-consumer” refers to a source of material that originates after the end consumer has used the material in consumer goods or products.

As used herein, the term “post-consumer recycle” (PCR) refers to a material that is produced after the end consumer has used the material and has disposed the material in a waste stream.

As used herein, the term “post-industrial” refers to a source of a material that originates during the manufacture of goods or products.

As used herein, the term “recycled polyethylene” may refer to polyethylene obtained from reclaimed polyethylene or from post-consumer recycle polyethylene or post-industrial polyethylene intended to be used as raw material in the production of new products.

In order to be denoted polyethylene, it should comprise at least 50 weight % ethylene monomers.

### SUMMARY OF THE INVENTION

The invention relates to a method for producing a polyethylene composition (P) from recycled polyethylene. In particular, the invention relates to a method in order to provide a polyethylene composition (P) from recycled polyethylene having a lower MFR (melt flow rate) than the recycled polyethylene used as starting material for the polyethylene composition (P).

When polyethylene is recycled the MFR is inherently affected. This will make the recycled polyethylene less useful because many applications require a defined, typically low, MFR.

In industrial production of virgin polyethylene, the MFR is controlled by the production parameters. Therefore, there is no need to change the MFR of virginpolyethylene. However, as the MFR is inherently affected in recycling, it would be desirable to provide means for controlling it in recycling of polyethylene in order to facilitate re-use of the recycled polyethylene. Further, means for controlling the MFR of recycled polyethylene implies that mixing of different batches of recycled polyethylene is facilitated.

A purpose of this invention is to lower the MFR of the recycled polyethylene composition (P).

The polyethylene products to be recycled are often reprocessed into a pellet that is suitable for selected purposes. Process streams from single or mixed sources of polyethylene products may be used for granulation. Granulated means that the plastic is compounded and pelletized. This may affect the MFR of the plastic, commonly referred to degradation of the plastic, even though recombination of degradation fragments at least partly will compensate for the degradation.

However, it has turned out that by introducing an ethylene copolymer (B) comprising hydrolysable silicon-containing groups, the MFR may be lowered during compounding, whereby compensating for the effects of degradation. An example of a suitable ethylene copolymer (B) is for example disclosed in EP2582743 A1. Compounding is suitably done in a compounding machine wherein the polymer is mixed. Compounding is done in suitable extruders with efficient mixing. A suitable level of mixing is required to get a homogenous polymer melt and even polymer properties.

The recycled polyethylene of this invention is for example intended for various applications for example film blowing, pipe extrusion, injection blow moulding, injection moulding and extrusion foaming applications. At least some of these applications require low MFR of the recycled polyethylene composition (P). Further, these applications benefit from the flexibility that comes from MFR adjustments.

In one application, the recycled polyethylene is blown into a film. This process requires that the MFR₂ of the recycled polyethylene is low, such as equal to or lower than 5 g/10 min, and controlled. The melt strength of the recycled polyethylene depends on the MFR and the homogeneity of the recycled polyethylene composition (P). Strain hardening is required to blow a film. If the recycled polyethylene composition is not homogenous, the film bubble will break or be unstable. To produce blown film bubble homogeneity is important. This is challenging for heterogenous materials obtained from recycling, especially post-consumer recycle (PCR). When polyethylene is recycled, chain scission may occur. The short chains formed by chain scission may increase the MFR of the recycled polyethylene. This will affect the melt strength of the recycled polyethylene. However, even though the short chains may recombine in various ways to at least partly compensate for the initial chain scission, is still beneficial to adjust the MFR to compensate for the effects of degradation by using an ethylene copolymer (B) comprising hydrolysable silicon-containing groups.

The MFR₂ for applications such as film blowing is typically below 5 g/10 min. The recycled polyethylene can be used for other applications such as pipe extrusion, injection blow moulding, injection moulding and extrusion foaming applications. The MFR is important for processability and mechanical strength of the final product.

In pipe applications, melt strength is important for dimensional stability of the pipe. When pipes are extruded, there is molten polymer inside the pipe walls. If the melt strength is low, the molten polymer will flow inside the pipe walls and the pipe will be thicker in the bottom part. To meet the mechanical properties of the pipe a low MFR is required.

Hence, the invention relates to a process of recycling a polyethylene composition (P) from recycled polyethylene (A) and a copolymer (B), wherein the recycled polyethylene composition (P) comprises:
a) at least 50 weight % of recycled polyethylene (A), and
b) 0.5 to 15 weight % of an ethylene copolymer (B) comprising hydrolysable silicon-containing groups.

The process of recycling a polyethylene composition (P) from recycled polyethylene (A) and a copolymer (B) comprises compounding said recycled polyethylene composition (P). The recycled polyethylene composition (P) treated by 0.5 to 15 weight % of an ethylene copolymer (B) comprising hydrolysable silicon-containing groups has at least 15% lower MFR₂ compared to the recycled polyethylene (A).

It is an object of the invention to control or lower the MFR of the recycled polyethylene composition (P). The recycled polyethylene (A) can be obtained from various processes of recycling. An example of recycled polyethylene (A) is reclaimed polyethylene that can be obtained from post-consumer recycling or post-industrial recycling. The physical properties of recycled polyethylene depend on the source. It is thus an object of the invention to provide an efficient, simple, and reliable control of the MFR of the recycled polyethylene. The object is reached by adding a sufficient amount of an ethylene copolymer (B) comprising hydrolysable silicon-containing groups. The recycled polyethylene composition (P) comprises at least 0.5 weight %, such as 0.5 to 15 weight %, of the ethylene copolymer (B) comprising hydrolysable silicon-containing groups.

Compounding polyethylene compositions is a well stablished technology. Thus, one advantage of the invention is that it can be implemented on present extrusion equipment.

The invention further relates to a recycled polyethylene composition (P). The recycled polyethylene composition (P) comprises:
a) at least 50 weight % of recycled polyethylene (A), and
b) 0.5 to 15 weight % of an ethylene copolymer (B) comprising hydrolysable silicon-containing groups
wherein said recycled polyethylene composition (P) has been compounded. The polyethylene composition (P) has a MFR₂ of 0.4 to 4 gram/10 min after the compounding.

Furthermore, the invention also relates to a recycled film comprising the recycled polyethylene composition (P), which comprises (as stated above):
a) at least 50 weight % of recycled polyethylene (A), and
b) 0.5 to 15 weight % of an ethylene copolymer (B) comprising hydrolysable silicon-containing groups.

The recycled polyethylene composition (P) is provided by compounding said recycled polyethylene composition (P).

The film is formed from the recycled polyethylene composition (P).

The invention also relates to the use of an ethylene copolymer (B) comprising hydrolysable silicon-containing groups as an MFR modifier for recycled polyethylene composition (P), wherein the recycled polyethylene composition (P) comprises:
a) at least 50 weight % of recycled polyethylene (A), and
b) 0.5 to 15 weight % of an ethylene copolymer (B) comprising hydrolysable silicon-containing groups.

Furthermore, the invention relates to the use of an ethylene copolymer (B) comprising hydrolysable silicon-containing groups as a compatibilizer modifier for recycled polyethylene composition (P). In embodiments relating to such use, the recycled polyethylene composition (P) comprises
a) at least 50 weight % of recycled polyethylene (A), and
b) 0.5 to 15 weight % of an ethylene copolymer (B) comprising hydrolysable silicon-containing groups.

The recycled polyethylene (A) comprises at least LDPE, HDPE, and/or various polar polyethylene from adhesion layers and possibly other polymer fractions. The ethylene copolymer (B) comprising the hydrolysable silicon-containing groups, is working as a compatibilizer to make a continuous matrix with melt strength. One effect of the ethylene copolymer (B) is that the homogeneity increases. The formed recycled polyethylene composition (P) has one phase that binds all parts together including even HDPE. Another effect is that the entire matrix takes the stress during film blowing.

### DETAILED DESCRIPTION

In one embodiment, the amount of recycled polyethylene (A) in the polyethylene composition (P) is at least 75 weight %, preferably at least 80 weight %, or most preferably 90 weight %.

The recycled polyethylene (A) has suitably an MFR₂ of 1 to 15 g/10 min, more suitably 5 to 12 g/10 min.

The addition of copolymer (B) comprising hydrolysable silicon-containing groups lowers the MFR of the recycled polyethylene composition (P). In a preferable embodiment of the invention, the MFR₂ of the recycled polyethylene is at least 20% lower compared to the recycled polyethylene (A), more suitable at least 30% lower.

The polyethylene composition (P) shall add up to 100%. The polyethylene composition (P) further can comprise additivities, pigments, and other polymer fractions. The polyethylene composition (P) can comprise pigment, suitably carbon black. This will increase the density of the recycled polyethylene composition (P). Additives are suitably added by use of masterbatches. If further polymer fractions are added into the recycled polyethylene composition (P) suitable virgin polyethylene is added. Most suitable no further polymer fraction is added.

In one embodiment the amount of a copolymer (B) comprising hydrolysable silicon-containing groups in the polyethylene composition (P) is from 1 to 10 weight %, more suitably 2 to 7 weight %, most suitably 2 to 5 weight %.

The amount of copolymer (B) to be added is decided in relation to the desired MFR of the recycled polyethylene composition (P). The desired MFR of the polyethylene composition (P) is decided by the intended end use of the recycled polyethylene composition (P). The MFR₂ of the recycled polyethylene composition (P) has suitably an MFR₂ of 0.4 to 10 gram/10 min, more suitably 0.4 to 4 gram/10 min and most suitably an MFR₂ of 1 to 3 gram/10 min. It is an objective of the invention to have a low amount of a copolymer (B) comprising hydrolysable silicon-containing groups. This will improve the compounding process. It will make it simpler, more stable and a more homogenous composition. The amount of hydrolysable silicon-containing groups in the polyethylene is from 0.1 to 5 weight %, more suitable 0.5 to 2 weight %.

In an embodiment of the invention the ethylene copolymer (B) comprising hydrolysable silicon-containing groups is a low-density polyethylene (LDPE). The LDPE can be either recycled or virgin. Virgin means that the polymer has not been used, i.e. it is not recycled. Due to the lack of recycled ethylene copolymer (B) comprising hydrolysable silicon-containing groups it is most suitable to use virgin sources. The LDPE is made in a high-pressure process. Another reason to use virgin ethylene copolymer (B) comprising hydrolysable silicon-containing groups is that its reactivity decreases with use, i.e. recycled ethylene copolymers comprising hydrolysable silicon-containing groups are less reactive.

The invention is preferably free from peroxide and/or peroxide residues. Peroxide and/or peroxide residues can come from various steps in reactive compounding. Polyethylene can be treated by reactive compounding with peroxide in order to decrease the MFR. The peroxide will crosslink the polyethylene chains and enlarge the molecules. The peroxide residues are smelly, and furthermore, the handling of peroxides is troublesome. Further, cross-linking could result in detrimental formation of a microgel. One object of the invention is to avoid peroxide and its residues.

In a preferred embodiment of the invention, the entire process is free from peroxide or peroxide residues. The copolymer (B) comprising hydrolysable silicon-containing groups is suitably free from peroxide or peroxide residues. Meaning that the copolymer (B) comprising hydrolysable silicon-containing groups is a polyethylene, suitably a LDPE that is made in a high-pressure process.

In another embodiment of the invention the copolymer (B) comprising hydrolysable silicon-containing groups is a polyethylene that is grafted. Polyethylene can be grafted with silane containing groups, such as ethylene-vinyl silane, which is well known in the art. As grafting of polyethylene typically requires use of peroxides, embodiments including use of polyethylene that is grafted with silane containing groups by use of peroxides are less preferred.

In a preferred embodiment of the invention, the recycled polyethylene composition (P) is free from silane condensation catalyst, such as dibutyl tin dilaurate (DBTL) or dioctyl tin dilaurate (DOTL). DBTL and DOTL are both organic tin compounds. Organic tin compounds are recognized as potentially toxic. Other examples of silane condensation catalysts are sulphonic acids. The purpose of a silane condensation catalyst is to crosslink the hydrolysable silicon-containing groups by a condensation reaction. It is preferred to avoid silane condensation catalyst since they are either harmful for the environment or involve strong acids. It is an objection of the invention to provide a recycling process of a polyethylene composition (P) wherein no silane condensation catalyst has been added through the recycling process. Thus, the recycled polyethylene composition (P) is free from silane condensation catalyst.

It is an object of the invention that articles made from a recycled polyethylene composition (P) are substantially free of odour and comparable to articles made from virgin polyethylene in relation to smell and mechanical properties.

The recycled polyethylene (A) suitably comprises LDPE, LLDPE and/or HDPE. Polyethylene, such as LDPE, LLDPE and/or HDPE, is the major component in the recycled polyethylene (A). The recycled polyethylene (A) may thus comprise at least 50 wt %, such as at least 60 wt %, at least 70 wt %, at least 80 wt %, or at least 90 wt % LDPE, LLDPE and/or HDPE. The recycled polyethylene (A) further may comprise an acidic part such as EMAA, EAA, MAH-grafted polyolefine and/or a low molecular weight organic acid. In a more suitable embodiment is the low molecular weight organic acid is a residue from the delamination process. Examples of low molecular weight organic acids are formic acid and acetic acid.

The recycled polyethylene (A) can be obtained from post-consumer recycling. The recycled polyethylene (A) can also be obtained from post-industrial recycling. In a suitable embodiment the recycled polyethylene (A) is from post-consumer recycling. This is a more demanding process since the recycled polyethylene (A) is a mixture of various polyethylenes and contaminated by other mixed streams of other common plastics.

In a preferred embodiment the recycled polyethylene (A) is obtained from post-consumer recycling of a liquid food board-based packages comprising liquid packaging board. The liquid food board-packages can be with and without aluminium layer. Most suitably the liquid food board-packages are with aluminium layer. It should be noted that all streams that originates from PCR stream has a high degree of recycled polymers from other streams.

The properties of the recycled polyethylene vary. The variation of density of recycled polyethylene can be from 890 kg/m³ to 990 kg/m³. The colour can be any, but mostly no pigment. The ash content may be below 2 weight % and the recycled polyethylene composition (P) is typically in the form of pellets or granules. The moisture content may be below 0.1 weight %. Most properties of the recycled polyethylene composition (P) are the same as for the recycled polyethylene (A).

### Experimental

### DRAWINGS

FIG. 1 depicts a photograph of a film from comparative example 4, RPM 40; and

FIG. 2 depicts a photograph of a film from Inventive example 7, RPM 60

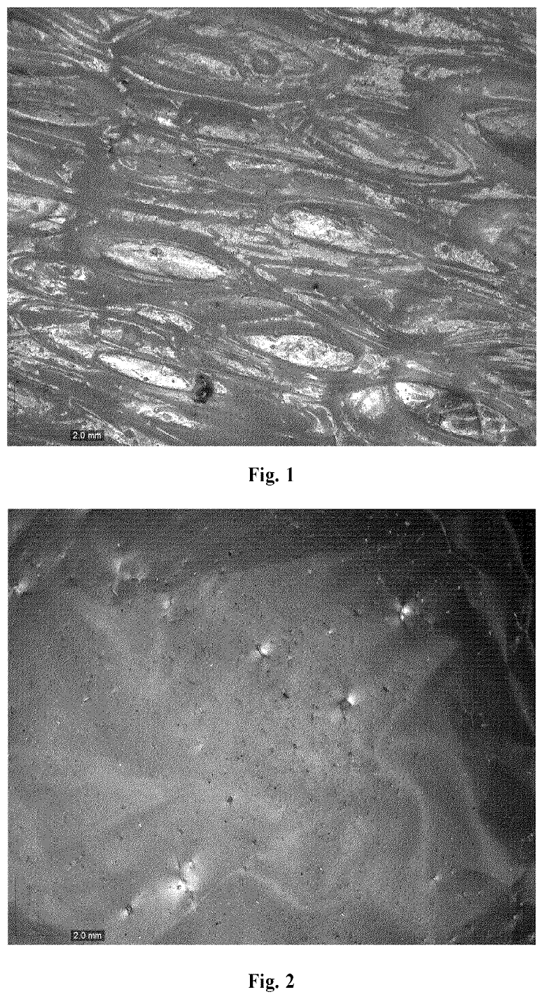

### MEASUREMENT METHODS

The melt flow rate (MFR) is determined as MFR₂ according to ISO 1133 and is indicated in g/10 min. The MFR is an indication of the flowability, and hence the processability, of the polymer. The higher the melt flow rate, the lower the viscosity of the polymer. The MFR₂ of polyethylene is measured at a temperature 190° C. and a load of 2.16 kg. All examples of compositions with at least 50 weight % of polyethylene are measured at 190° C. The melt flow rate is preferably determined according to ISO 1133-2:2011.

Complex viscosity was measured at 190° C. using a TA Instrument ARES-G2 TA rheometer. The configuration is a 25 mm plate/plate geometry with 1% strain. Frequency sweep was from 100 to 0.1 rad/sec.

Elongation viscosity was measured at 150° C. using a TA Instrument ARES-G2 rheometer equipped with an extensional viscosity fixture (EVF). The extension rate (Hencky rate) was 0.5 1/s and the final Hencky strain was 3.4.

Optical microscopy was performed using a Dino-Lite Digital microscope at 20× magnification.

### Materials

EVS is LE-4423, commercially available from Borealis. The EVS is a low-density polyethylene copolymer comprising hydrolysable silicon-containing groups. The copolymer is made in a high-pressure reactor. The density of the polymer is 923 kg/m³ and it has an MFR₂ of 1.0 g/10 min.

Recycled polyethylene 1 has a MFR₂ of 8.7 g/10 min. The polymer is obtained by collecting various liquid food board-based packages mainly from packages with layers of board, polymer and aluminium. First the board layer is separated, and then the aluminium layer is separated by an acid-based delamination method prior to regranulation. The liquid food board packages originate from PCR and comprise the following polymers regranulated: LDPE>LLDPE>ethylene-co-acrylic and/or-co-methacrylic acid>HDPE>PET>MAH-grafted polyolefins and pigments. The PCR further comprises contaminations that are decreased by melt filtration during the regranulation process.

Recycled polyethylene 2 has a MFR₂ of 4.2 g/10 min. The polymer is obtained by collecting various liquid food board-based packages mainly from packages with layers of board, polymer and aluminium. First the board layer is separated, and then the aluminium layer is separated by an acid-based delamination method prior to regranulation. The liquid food board packages originate from PCR and comprise the following polymers regranulated: LDPE>LLDPE>ethylene-co-acrylic or-co-methacrylic acid>HDPE>PET>

MAH-grafted polyolefins and pigments. The PCR further comprises contaminations decreased or removed by melt filtration during the regranulation process.

Recycled polyethylene 3 has a MFR₂ of 4.4 g/10 min. The polymer is obtained by collecting various liquid food board-based packages mainly from packages with layers of board, polymer and aluminium. First the board layer is separated, and then the aluminium layer is separated by an acid-based delamination method prior to regranulation. The liquid food board packages originate from PCR and comprise the following polymers regranulated: LDPE>LLDPE>ethylene-co-acrylic or-co-methacrylic acid>HDPE>PET>MAH-grafted polyolefins and pigments. The PCR further comprises contaminations decreased or removed by melt filtration during the regranulation process.

Recycled polyethylene 4 has a MFR₂ of 3.6 g/10 min. The polymer is obtained by collecting various liquid food board-based packages mainly from packages with layers of board, polymer and aluminium. First, the board layer is separated, and then the aluminium layer is separated by an acid-based delamination method prior to regranulation. The liquid food board packages originate from PCR and comprise the following polymers regranulated: LDPE>LLDPE>ethylene-co-acrylic or-co-methacrylic acid>HDPE>PET>MAH-grafted polyolefins and pigments. The PCR further comprises contaminations decreased or removed by melt filtration during the regranulation process.

LDPE-22 is 1922NO and is commercially available from Sabic. The polymer is made in a tubular reactor and is virgin and additive free. The density of the polymer is 919 kg/m³ and it has an MFR₂ of 22 g/10 min.

LDPE-7 is 19N430 and is commercially available from Ineos. The density of the polymer is 920 kg/m³ and it has an MFR₂ of 7.5 g/10 min.

LDPE-1 is LDPE 320E and is commercially available from Dow. The density of the polymer is 925 kg/m³ and it has an MFR₂ of 1 g/10 min.

### Examples

The compositions shown in Table 1 were compounded in a single screw extruder SSE (Axon BX-25) at 220 rpm equipped with a water bath at room temperature before strand pellettization. The temperature settings of the extruder were 170, 220, 220, 220, 220, 220° C.

TABLE 1

| | Comp. | Comp. | Inventive | Inventive | Inventive |
|---|---|---|---|---|---|
| | example 1 | example 2 | example 1 | example 2 | example 3 |
| Recycled | 100 | | 97.5 | 95 | 90 |
| polyethylene 1 | | | | | |
| [weight %] | | | | | |
| EVS | | 100 | 2.5 | 5 | 10 |
| [weight %] | | | | | |
| MFR₂ | 8.7 | 0.9 | 2.9 | 1.1 | 0.4 |
| [g/10 min] | | | | | |
| Relative | 0% | na | −67% | −87% | −95% |
| difference | | | | | |
| [+/− %] | | | | | |

In comparative example 1 the MFR₂ change has been measured in polymer composition with only recycled polyethylene 1. In Table 1 all examples have been preheated 5 minutes before the MFR₂ were measured.

In comparative example 2 only EVS is used. The MFR₂ remains similar. In inventive example 1-3 recycled polyethylene 1 is mixed with different amounts of EVS. The MFR₂ decreases with added amount of EVS.

The relative difference is calculated as the ratio of MFR₂ of the recycled polyethylene composition (P) divided by MFR₂ of the recycled polyethylene (A) minus 100%.

The examples in Table 2 were compounded in a single screw extruder SSE (Axon BX-25) at 220 rpm equipped with a water bath at room temperature before strand pellettization. The temperature settings of the extruder were 170, 220, 220, 220, 220, 220° C.

TABLE 2

| | Comp. | Inv. | Inv. | Comp. | Inv. | Inv. | Comp. | Comp. |
|---|---|---|---|---|---|---|---|---|
| | Ex. 3 | Ex. 4 | ex. 5 | Ex. 4 | Ex. 6 | Ex. 7 | Ex. 5 | Ex. 6 |
| Recycled | 100 | 97.5 | 95 | | | | | |
| polyethylene | | | | | | | | |
| 2 | | | | | | | | |
| [weight %] | | | | | | | | |
| Recycled | | | | 100 | 97.5 | 95 | 97.5 | 95 |
| polyethylene | | | | | | | | |
| 3 | | | | | | | | |
| [weight %] | | | | | | | | |
| LDPE-1 | | | | | | | 2.5 | 5 |
| EVS | | 2.5 | 5 | | 2.5 | 5 | | |
| [weight %] | | | | | | | | |
| MFR₂ | 4.2 | 3.0 | 1.3 | 4.4 | 2.1 | 1.0 | 4.2 | 3.9 |
| [g/10 min] | | | | | | | | |
| Relative | 0% | −28% | −69% | 0% | −52% | −77% | −4% | −11% |
| difference | | | | | | | | |
| [+/− %] | | | | | | | | |

In Table 2 all examples have been preheated 5 minutes before the MFR₂ were measured. The results are consistent with the results from Table 1.

5 The extruder and process conditions in Table 3 are the same as in Table 2.

TABLE 3

| | Comp. | Inventive | Inventive |
|---|---|---|---|
| | example 7 | example 8 | example 9 |
| Recycled | 100 | 97.5 | 95 |
| polyethylene | | | |
| 4 [weight %] | | | |
| EVS | | 2.5 | 5 |
| [weight %] | | | |
| MFR₂ | 3.6 | 1.3 | 0.48 |
| [g/10 min] | | | |
| Relative | 0% | −64% | −87% |
| difference | | | |
| [+/− %] | | | |

Table 3 discloses further examples of the invention.

In Table 4 the complex viscosity changes are measured. The compositions were compounded on a single screw extruder SSE (Axon BX-25) at 220 rpm with the temperature settings of 170, 220, 220, 220, 220, 220° C. before strand pellettization. The samples were then compression moulded in in a hydraulic press machine.

Press temperature 155° C.

Time: 2 min pre-heating, 2 min full press, 5 min cooling to prepare a cylindrical sample (25 mm diameter and 1 mm thickness).

The complex viscosity was measured at 190° C. The configuration was a 25 mm plate/plate geometry with 1% strain. Frequency sweep was from 100 to 0.1 rad/sec.

TABLE 4

| | Comp. | Inventive | Inventive | Comp. | Inventive | Inventive |
|---|---|---|---|---|---|---|
| | example | example | example | example | example | example |
| | 1 | 1 | 2 | 3 | 4 | 5 |
| Recycled | 100 | 97.5 | 95 | | | |
| polyethylene | | | | | | |
| polymer 1 | | | | | | |
| [weight %] | | | | | | |
| Recycled | | | | 100 | 97.5 | 95 |
| polyethylene | | | | | | |
| 2 | | | | | | |
| [weight %] | | | | | | |
| EVS | | 2.5 | 5 | | 2.5 | 5 |
| [weight %] | | | | | | |
| Complex | 2705 | 3954 | 4423 | 2727 | 3076 | 4281 |
| viscosity | | | | | | |
| [Pa · s] | | | | | | |
| 0.1 rad/s | | | | | | |
| Complex | 783 | 1408 | 1442 | 1567 | 1754 | 2173 |
| viscosity | | | | | | |
| [Pa · s] | | | | | | |
| 1 rad/s | | | | | | |
| Complex | 153 | 212 | 199 | 269 | 300 | 331 |
| viscosity | | | | | | |
| [Pa · s] | | | | | | |
| 100 rad/sec | | | | | | |

The addition of EVS to the recycled polyethylene increases the complex viscosity of the composition. This is a proof of molecular enlargement and shear thinning of the recycled polyethylene composition (P).

In Table 5 the effect of EVS on the elongation viscosity is reported for Recycled polyethylene 2. The effect of strain hardening (higher melt elasticity and viscosity) for the inventive example can be observed.

TABLE 5

| | Comp. | Inventive | Inventive |
|---|---|---|---|
| | example 3 | example 4 | example 5 |
| Recycled | 100 | 97.5 | 95 |
| polyethylene 2 | | | |
| [weight %] | | | |
| EVS | | 2.5 | 5 |
| [weight %] | | | |
| Elongation viscosity | 2724 | 3015 | 3135 |
| [Pa · s] after 0.01 s | | | |
| Elongation viscosity | 119492 | 134515 | 211241 |
| [Pa · s] after 2.0 s | | | |
| Maximum elongation | 125522 | 177091 | 437487 |
| viscosity [Pa · s] | | | |
| Step time at maximum | 2.6 | 3.1 | 3.8 |
| elongation viscosity (s) | | | |

The examples show the improved melt elasticity properties of the invention.

Additional examples of mixing virgin LDPE with different MFR₂ with EVS are shown in Table 6. The compositions were made according to Table 1.

TABLE 6

| | Comp. | Comp. | Comp. | Comp. | Comp. |
|---|---|---|---|---|---|
| | example | example | example | example | example |
| | 8 | 9 | 10 | 11 | 12 |
| LDPE-22 | 100 | 97.5 | | | |
| [weight %] | | | | | |
| LDPE-7 | | | 100 | 97.5 | 95 |
| EVS | | 2.5 | | 2.5 | 5 |
| [weight %] | | | | | |
| MFR₂ | 21.1 | 19.1 | 7.2 | 6.7 | 6.5 |
| [g/10 min] | | | | | |
| Relative | 0% | −9% | 0% | −7% | −10% |
| difference | | | | | |
| [+/− %] | | | | | |

When adding EVS to virgin LDPE the MFR₂ is decreased. The decrease is due to the low MFR₂ of the EVS and the decrease of MFR₂ is significantly lower compared to that observed in the inventive examples.

Additional film examples have been produced on a laboratory scale film blowing machine. The examples in Table 7 show the improved film forming properties of the invention. The recycled polyethylene compositions from comparative example 4 and inventive examples 6 and 7 were compounded on a single screw Brabender & Collins extruder 19/25D, air cooled, equipped with a barrier screw 2.5:1 with a mixing element. The revolutions per minute (RPM) of the extruder were varied.

Film blowing die head with a cooling ring (diameter 2 cm) Temperature setting (profile): 190-210-210-210° C.

TABLE 7

| | Comp. | Inventive | Inventive |
|---|---|---|---|
| | example 4 | example 6 | example 7 |
| Recycled | 100 | 97.5 | 95 |
| polyethylene 3 | | | |
| [weight %] | | | |
| EVS | | 2.5 | 5 |
| [weight %] | | | |
| MFR₂ | 4.4 | 2.1 | 1.0 |
| [g/10 min] | | | |
| Relative | 0% | −52% | −77% |
| difference | | | |
| [+/− %] | | | |
| RPM 40 | No film formed | Film formed, | Film formed, |
| | | Greatly improved | Film quality |
| | | film quality stable | unstable |
| RPM 60 | No film formed | | Film formed, |
| | | | Greatly improved |
| | | | film quality stable |

The inventive examples show that stable film production can be achieved by the invention. The MFR is lowered and the blowability is improved.

A microscope photo of a film blown from the recycled material without EVS (comparative example 4) shows an inhomogeneous material with separate phases. The dispersed phases are elongated in the machine direction due orientation effects at the exit of the die. During film blowing, the continuous phase will take the stresses and as the phase is only a part of the total volume the stress in this phase becomes too high, easily leading to breakage. With the addition of 5% EVS the microscope photo shows a homogenous material. The EVS works as a compatibilizer that evens out the phase boundaries. Meaning that the phases interact mechanically, which means that the total volume of the material can take up stresses. Thus, improved film blowing properties of inventive example 6 and 7.

1. A process of recycling a polyethylene composition, wherein the recycled polyethylene composition comprises:
a) at least 50 weight % of recycled polyethylene, and
b) 0.5 to 15 weight % of an ethylene copolymer comprising hydrolysable silicon-containing groups,
wherein the process comprises compounding said recycled polyethylene composition, and wherein the recycled polyethylene composition treated by 0.5 to 15 weight % of an ethylene copolymer comprising hydrolysable silicon-containing groups has at least 15% lower MFR₂ compared to the recycled polyethylene.

2. The process according to claim 1, wherein the amount of recycled polyethylene in the recycled polyethylene composition is at least 75 weight %.

3. The process according to claim 1, wherein the amount of a copolymer comprising hydrolysable silicon-containing groups in the recycled polyethylene composition is from 1 to 10 weight %.

4. The process according to claim 1, wherein the ethylene copolymer comprising hydrolysable silicon-containing groups is an LDPE.

5. The process according to claim 4, wherein the copolymer comprising hydrolysable silicon-containing groups is free from peroxide or peroxide residues.

6. The process according to any prior claim 5, wherein the recycling process is free from silane condensation catalyst.

7. The process according to claim 1, a copolymer comprising hydrolysable silicon-containing groups is a polyethylene that is grafted.

8. The process according to claim 1, wherein recycled polyethylene comprises LDPE, LLDPE, and/or HDPE.

9. The process according to claim 8, wherein the polyethylene composition comprises an acidic part.

10. The process according to claim 9, wherein the acidic part comprises EMAA, EAA, MAH grafted polyolefin and/or a low molecular weight organic acid.

11. The process according to claim 8, wherein the recycled polyethylene is obtained from a liquid food board-based packages.

12. A recycled polyethylene composition, wherein the recycled polyethylene composition comprises:
a) at least 50 weight % of recycled polyethylene, and
b) 0.5 to 15 weight % of an ethylene copolymer comprising hydrolysable silicon-containing groups,
wherein said recycled polyethylene composition is compounded, said polyethylene composition after the compounding having a MFR₂ of 0.4 to 4 g/10 min.

13. A recycled film, wherein the film is provided by forming the recycled polyethylene composition according to claim 12 into a film.

14-15. (canceled)
